(19) United States
(12) Patent Application Publication
(10) Pub. No.: US 2026/0268261 A1
(43) Pub. Date: Sep. 10, 2026

(54) KPI EVALUATION SYSTEM AND METHOD

(71) Applicant: HITACHI, LTD., Tokyo (JP)

(72) Inventors: Hiromitsu Nakagawa, Tokyo (JP); Shigenori Matsumoto, Tokyo (JP)

(73) Assignee: HITACHI, LTD., Tokyo (JP)

(21) Appl. No.: 19/491,295

(22) PCT Filed: Jun. 6, 2024
(86) PCT No.: PCT/JP2024/020713

§ 371 Date: Dec. 8, 2025

(30) Foreign Application Priority Data
Jun. 29, 2023 (JP) 2023-106593

(51) Int. Cl. G06Q 10/0639

(52) U.S. Cl. CPC G06Q 10/06393

(57) ABSTRACT

Provided is a technology capable of analyzing business KPIs that make it possible to obtain a plurality of solutions which are harmonized as a whole while taking feasibility into consideration. A KPI evaluation system is a system for evaluating a KPI(s) (Key Performance Indicator(s)) related to business of a stakeholder, wherein a computer including at least a processor, a memory, and a storage device defines relationships between challenges of respective stakeholders regarding two or more stakeholders including the above-mentioned stakeholder; and associates KPI settings of stakeholders, excluding the above-mentioned stakeholder, with the challenges of the respective stakeholders based on the defined relationships between the challenges.

### TECHNICAL FIELD

The present invention relates to a technology for evaluating KPIs in business.

### BACKGROUND ART

In recent years, in response to the diversification of end-user needs and the diversification of corporate services, it has become one of important factors to fundamentally review conventional-style businesses and systems in order to become a company to be chosen by customers.

Conventionally, companies have set business-related KPIs (Key Performance Indicators) to achieve business challenges and have carried out measures for the enhancement of the KPIs. However, in the modern age where the needs and the services are diversified, it is important to evaluate the KPIs not only on the company side, but also on the whole business focused on the KPIs on the customers' side (for example, PTL 1 and PTL 2).

### CITATION LIST

### Patent Literature

PTL 1: Japanese Patent Application Laid-Open (Kokai) Publication No. 2021-144700

PTL 2: Japanese Patent Application Laid-Open (Kokai) Publication No. 2014-095952

### SUMMARY OF THE INVENTION

### Problems To Be Solved By The Invention

The technology of PTL1 can apply KPIs defined for each grouped object and create a report of analysis results, but there is a problem of group-specific optimization.

The technology of PTL2 can optimize the entire business process by using a synthetic formula of multi-task KPIs, but there is a problem that the feasibility becomes a specific solution which is unclear.

The present invention was devised in light of the above-described problems and it is an object of the invention to provide a technology that can analyze the business KPIs that make it possible to obtain a plurality of solutions which are harmonized as a whole in consideration of the feasibility.

### Means to Solve the Problems

A KPI evaluation system according to the present invention is a system for evaluating a KPI (Key Performance Indicator) related to business of a stakeholder, wherein a computer including at least a processor, a memory, and a storage device: defines a relationship between challenges of respective stakeholders regarding two or more stakeholders including the above-mentioned stakeholder; and associates KPI settings of a stakeholder, which is not the above-mentioned stakeholder, with the respective stakeholders' challenges based on the defined relationship between the challenges.

Other than the above, the problems and their solutions which are disclosed by this application will be clarified by the section of DESCRIPTION OF EMBODIMENTS and drawings.

### Advantageous Effects of the Invention

According to the present invention, it is possible to analyze the business KPIs that make it possible to obtain a plurality of solutions which are harmonized as a whole in consideration of the feasibility.

### BRIEF DESCRIPTION OF DRAWINGS

FIG. 1 is a diagram illustrating an example of the configuration of the entire business KPI evaluation system according to Examples 1 and 2;

FIG. 2 is a diagram illustrating an example of functional blocks of the business KPI evaluation system according to Example 1;

FIG. 3 is a diagram illustrating a configuration example of each table stored in a customer information database;

FIG. 4 is a diagram illustrating a configuration example of each table stored in a relationship database;

FIG. 5 is a flowchart illustrating an example of a flow of graph definition processing;

FIG. 6 is a flowchart illustrating an example of a flow of KPI relationship definition processing;

FIG. 7 is a flowchart illustrating an example of a flow of challenge relationship definition processing;

FIG. 8 is a flowchart illustrating an example of a flow of challenge selection processing;

FIG. 9 is a flowchart illustrating an example of a flow of KPI calculation processing;

FIG. 10 is a diagram illustrating an example of functional blocks of the business KPI evaluation system according to Example 2;

FIG. 11 is a diagram illustrating a configuration example of each table stored in the relationship database;

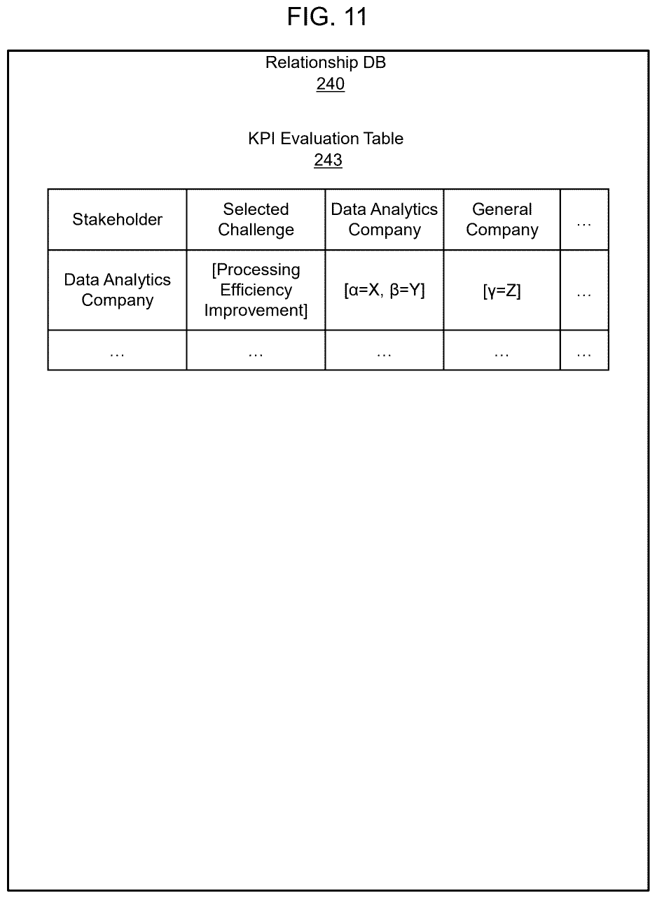

FIG. 12 is a flowchart illustrating an example of a flow of KPI calculation accumulation processing;

FIG. 13 is a flowchart illustrating an example of a flow of UI control processing;

FIG. 14 is a diagram illustrating an example of the configuration of a KPI evaluation check screen; and

FIG. 15 is a flowchart illustrating an example of a flow of accumulation reference processing.

### DESCRIPTION OF EMBODIMENTS

In the description indicated below, an “interface unit” may be one or more interface devices. The one or more communication interfaces may be one or more communication interface devices of the same type (for example, one or more NICs [Network Interface Cards]) or two or more communication interface devices of different types (for example, an NIC and an HBA [Host Bus Adapter]).

Furthermore, in the description indicated below, a “storage device” is one or more memories. At least one memory may be a volatile memory or a nonvolatile memory. The storage device may include one or more PDEVs in addition to the one or more memories. The “PDEV” means a physical storage device and may typically be a nonvolatile storage device (for example, an auxiliary storage device). The PDEV may be, for example, an HDD (Hard Disk Drive) or an SSD (Solid State Drive).

Furthermore, in the description indicated below, a “processor unit” is one or more processors. At least one processor device may typically be a CPU (Central Processing Unit). The processor may include a hardware circuit which performs part or all of processing.

Furthermore, in the description indicated below, the expression “kkk unit” (excluding the interface unit, the storage unit, and the processor unit) may be sometimes used to explain a function; however, the function may be implemented by execution of one or more computer programs by the processor unit or may be implemented by one or more hardware circuits (such as FPGA [Field-Programmable Gate Array] or ASIC [Application Specific Integrated Circuit]). If the function is implemented by the execution of a program by the processor unit, specified processing is performed by using, for example, the storage unit and/or the interface unit as appropriate and, therefore, the function may be considered as at least part of the processor unit. The processing explained by referring to the function as a subject may be the processing executed by the processor unit or by a device which has that processor unit. The program may be installed from a program source. The program source may be, for example, a program distribution computer or a computer-readable recording medium (such as a non-transitory recording medium). An explanation of each function is one example, and a plurality of functions may be gathered as one function or one function may be divided into a plurality of functions.

Furthermore, in the description indicated below, information may be sometimes described by using an expression like an “xxx table”; however, such information may be expressed by data of whatever structure. Specifically speaking, the “xxx table” can be paraphrased as “xxx information” in order to show that the information does not depend on the data structure. Furthermore, in the description indicated below, the structure of each table is one example and one table may be divided into two or more tables or all or some of two or more tables may be one table.

Furthermore, in the description indicated below, a “time of day” may be expressed in year, month, date, hours, minutes, and seconds; however, the units of the time of day may be rougher or finer than the above-described units or different units may be used.

Furthermore, in the description indicated below, a “data set(s)” means data composed of one or more data elements (one chunk of logical electronic data) and may be any one of, for example, a record(s), a file(s), a key value pair(s), and a tuple(s).

Furthermore, in the description indicated below, there may be a case where processing will be explained by referring to a “program” as a subject; however, the processing explained by referring to the program as a subject may be processing performed by a processor or by a device having that processor. Moreover, two or more programs may be implemented as one program or one program may be implemented as two or more programs.

Furthermore, in the description indicated below, a “KPI evaluation system” may be a system configured of one or more physical computers or may be a system (such as a cloud computing system) which is implemented in a physical calculation resource group (such as a cloud infrastructure). The KPI evaluation system “displaying” display information may be to display the display information on a display device possessed by a computer or may be for a computer to transmit the display information to a display computer (in the latter case, the display information is displayed by the display computer).

Some embodiments of the present invention will be described in detail with reference to the drawings.

Incidentally, in the description below, any redundant explanation may sometimes be omitted by assigning common reference numerals to the same or similar configurations.

Moreover, if there are a plurality of elements having the same or similar functions, different subscripts may sometimes be attached to the same reference numeral to describe and distinguish between the plurality of elements. On the other hand, if it is unnecessary to distinguish between the plurality of elements, they may sometimes be described by omitting the subscripts.

### Example 1

### Configuration Example of KPI Evaluation System 100

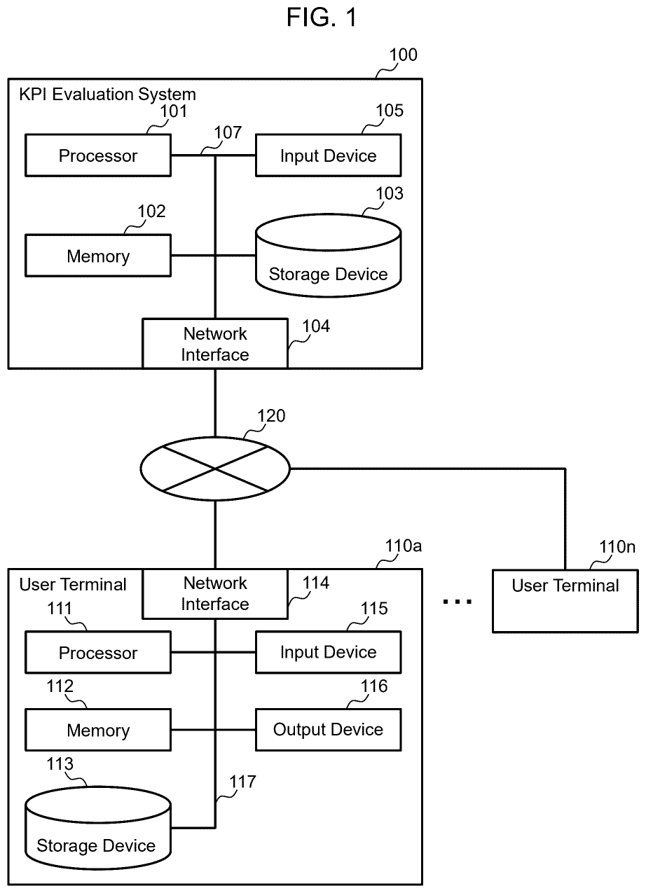

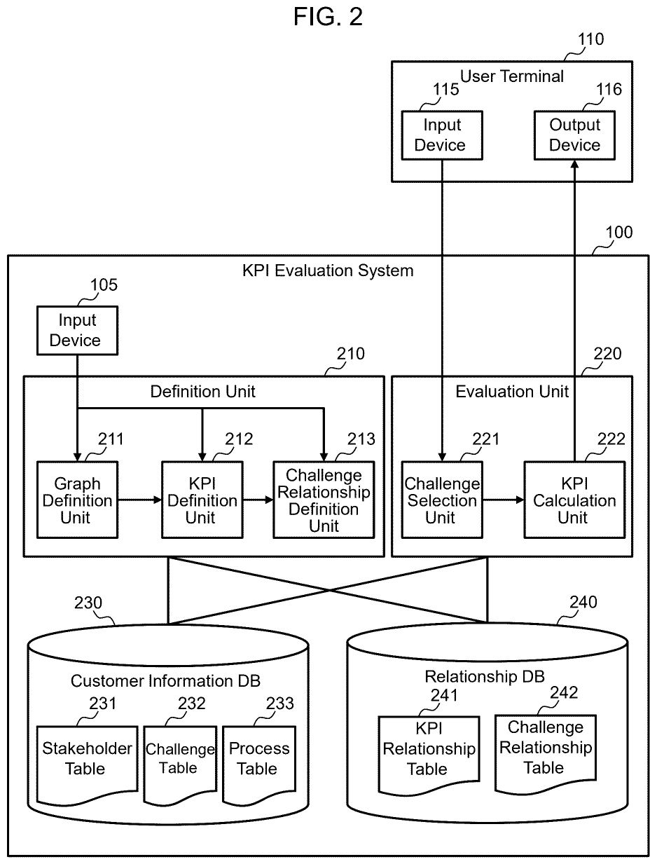

Firstly, an explanation will be provided about a configuration example of a KPI evaluation system 100 according to an embodiment with reference to FIGS. 1 and 2. FIG. 1 is a diagram illustrating an example of the configuration of the entire KPI evaluation system 100 according to Examples 1 and 2. Moreover, FIG. 2 is a diagram illustrating an example of functional blocks of the KPI evaluation system 100 according to Example 1.

### Configuration Example of the Entire System

The KPI evaluation system 100 according to this embodiment is a computer system capable of evaluating KPIs and is implemented by a computer device or a server device equipped with the respective configurations described later.

The KPI evaluation system 100 is connected with user terminals 110a, 110b, 110c, and so on up to 110n (hereinafter collectively referred to as the “user terminal 100” when they are mentioned collectively or when they are not distinguished from each other) such as laptop PCs, tablets, and smartphones possessed by users of the KPI evaluation system 100, via an appropriate communication network 120 such as the Internet or dedicated lines so that they can communicate data with each other. Incidentally, the KPI evaluation system 100 and the communication network 120 may be connected by wire via well-known communication equipment (which is not illustrated in the drawing) or may be connected wirelessly. Moreover, each user terminal 110 and the communication network 120 may be connected wirelessly or by wire, respectively.

Moreover, for example, another computer device(s) or server device(s) (hereinafter also referred to as the “other device(s)”) may be connected with this KPI evaluation system 100 via the communication network 120 so that they can communicate data with each other. In this case, the other devices and the communication network 120 may be connected by wire via well-known communication equipment (which is not illustrated in the drawing) or may be connected wirelessly.

Incidentally, this embodiment has described that the KPI evaluation system 100 is composed of one device. However, for example, the KPI evaluation system 100 may be composed of a plurality of devices.

Moreover, this embodiment has described that the KPI evaluation system 100, the user terminal 110, and the other device(s) are separate devices. However, the KPI evaluation system 100, the user terminal 110, and the other device(s) may be configured by the same device. In this case, the KPI evaluation system may be configured, for example, as a system including the user terminal 110 and the other device(s). Also, for example, the KPI evaluation system may be configured in a form including some or all functions served by the user terminal 110 and the other device(s).

### Hardware Configuration Example of KPI Evaluation System 100

Next, an explanation will be provided about an example of a hardware configuration of the KPI evaluation system 100 with reference to FIG. 1.

The KPI evaluation system 100 according to this embodiment is implemented by one general-purpose computer device as illustrated by an example in FIG. 1. The following explanation will be provided by assuming that the KPI evaluation system 100 is implemented by one general-purpose computer device including one or more processors 101, one or more memories 102, one or more storage devices 103, one or more network interfaces 104, one or more input devices 105, and a wired or wireless communication line 107 which connects them.

Specifically speaking, the KPI evaluation system 100 has a storage device including the memory 102 and the storage device 103, an interface device including the network interface 104 and the input device 105, and the processor 101 which is connected to them.

The storage device 103 is an auxiliary storage device composed of a nonvolatile storage element(s) such as a flash memory. Specific examples of the storage device 103 can include an SSD(s) (Solid State Drive(s)) and an HDD(s) (Hard Disk Drive(s)). The storage device 103 stores at least a KPI evaluation program. The KPI evaluation program is a computer program for implementing necessary functions as the KPI evaluation system 100.

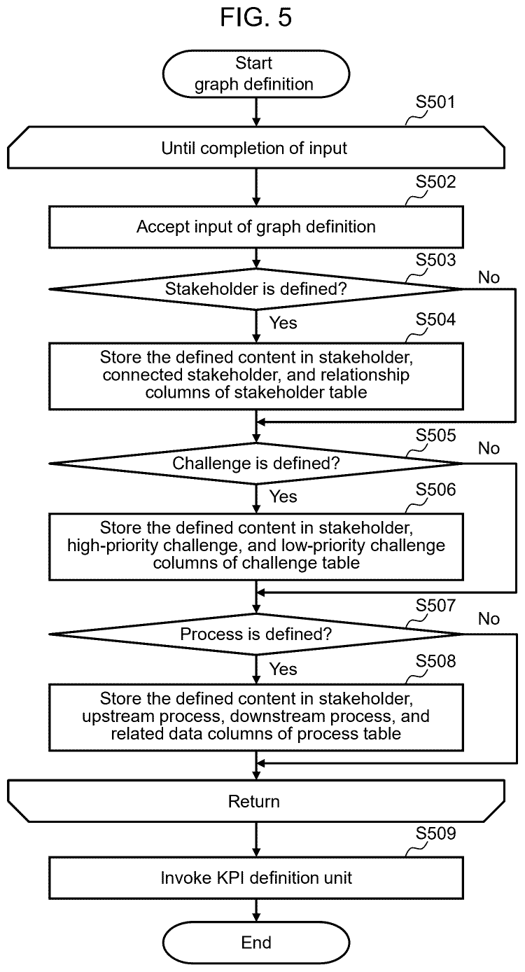

Specifically speaking, as the KPI evaluation program is executed by the processor 101, various processing including those which are listed below and which will be described later in relation to FIGS. 5 to 9 and FIGS. 12 to 14, respectively, are performed: processing relating to the graph definition (hereinafter referred to as “graph definition processing”), processing relating to the KPI relationship definition (hereinafter referred to as “KPI relationship definition processing”), processing relating to the challenge relationship definition (hereinafter referred to as “challenge relationship definition processing”), processing relating to the challenge selection (hereinafter referred to as “challenge selection processing”), processing relating to the KPI calculation (hereinafter referred to as “KPI calculation processing”), processing relating to the KPI calculation accumulation (hereinafter referred to as “KPI calculation accumulation processing”), processing relating to the UI control (hereinafter referred to as “UI control processing”), processing relating to the accumulation reference (hereinafter referred to as “accumulation reference processing”), and so on.

Incidentally, the KPI evaluation program may be installed from a program source. The program source may be, for example, a program distribution computer or a computer-readable storage medium. Also, the KPI evaluation program may be configured of a device driver, an operating system, various kinds of application programs positioned in an upper layer of the above-mentioned device driver or operating system, or a library for providing functions in common with these programs. Furthermore, two or more programs may be implemented as one KPI evaluation program or one KPI evaluation program may be implemented as two or more programs.

The memory 102 is a main storage device mainly composed of a volatile storage element such as a RAM (Random Access Memory). The memory 102 temporarily retains data indicating various kinds of information read from the storage device 103 and various kinds of data acquired via the network interface 104 and/or the input device 105.

The processor 101 is a processor device such as a CPU (Central Processing Unit) and various kinds of co-processors. This processor 101 serves as a control unit (which is not illustrated in the drawing) that performs overall control of the KPI evaluation system 100 itself by invoking a KPI evaluation program to the memory 102 and executing it, and performs various kinds of processing such as arithmetic processing and judgment processing.

The interface device includes the network interface 104 for connecting to the communication network 120 and communicating with the user terminal(s) 110 and other devices, etc., and the input device 105.

### Hardware Configuration Example of User Terminal 10

An example of a hardware configuration of the user terminal 110 will be explained with reference to FIG. 1.

The user terminal 110 of this embodiment is implemented by one general-purpose computer device as illustrated by the example in FIG. 1. The following explanation will be provided assuming that the user terminal 110 is implemented by one general-purpose computer device including one or more processors 111, one or more memories 112, one or more storage devices 113, one or more network interfaces 114, one or more input devices 115, one or more output device 116, and a wired or wireless communication line 117 connecting them.

Specifically speaking, the user terminal 110 has a storage device including the memory 112 and the storage device 113, an interface device including the network interface 114, the input device 115, and the output device 116, and the processor 111 connected to them.

The storage device 113 is an auxiliary storage device composed of a nonvolatile storage element(s) such as a flash memory. Specific examples of the storage device 113 can include an SSD(s) (Solid State Drive(s)) and an HDD(s) (Hard Disk Drive(s)). The storage device 113 stores various kinds of computer programs including a program for implementing necessary functions as the user terminal 110.

Incidentally, the above-described program may be installed from a program source. The program source may be, for example, a program distribution computer or a computer-readable storage medium. Also, the above-described program may be configured of a device driver, an operating system, various kinds of application programs positioned in an upper layer of the above-mentioned device driver or operating system, or a library for providing functions in common with these programs. Furthermore, two or more programs may be implemented as one program or one program may be implemented as two or more programs.

The memory 112 is a main storage device mainly composed of a volatile storage element such as a RAM (Random Access Memory). The memory 112 temporarily retains data indicating various kinds of information read from the storage device 113 and various kinds of data acquired via the network interface 114 and/or the input device 115.

The processor 111 is a processor device such as a CPU (Central Processing Unit) and various kinds of co-processors. This processor 111 serves as a control unit that performs overall control of the user terminal 110 itself by invoking the aforementioned program to the memory 112 and executing it, and performs various kinds of processing such as arithmetic processing and judgment processing.

The interface device includes the network interface 114 for connecting to the communication network 120 and communicating with the KPI evaluation system 100 and other devices, etc., and an I/O (Input/Output) interface composed of the input device 115 and the output device 116.

### Functional Block Example of KPI Evaluation System 100 According to Example 1

Next, an example of various kinds of functional blocks possessed by the KPI evaluation system 100 according to Example 1 will be explained with reference to FIG. 2. Incidentally, each block explained below indicates a function-based block, but not a hardware-based configuration.

The KPI evaluation system 100 is configured by including respective functional blocks of a control unit, a storage unit, and a communication unit, as well as a user interface unit composed of an input unit and an output unit (none of which is illustrated in the drawing).

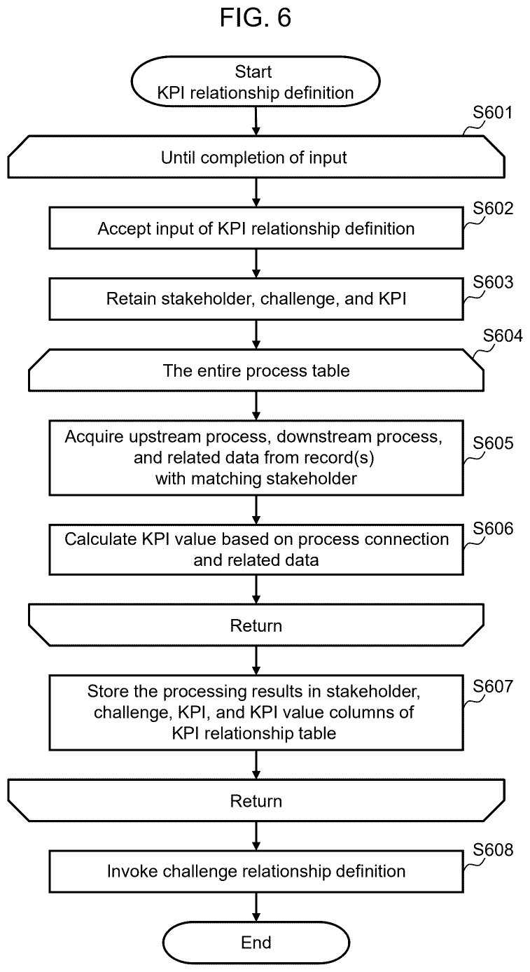

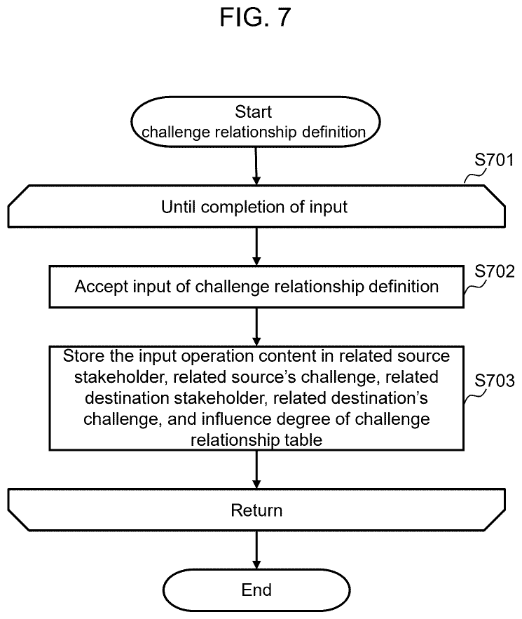

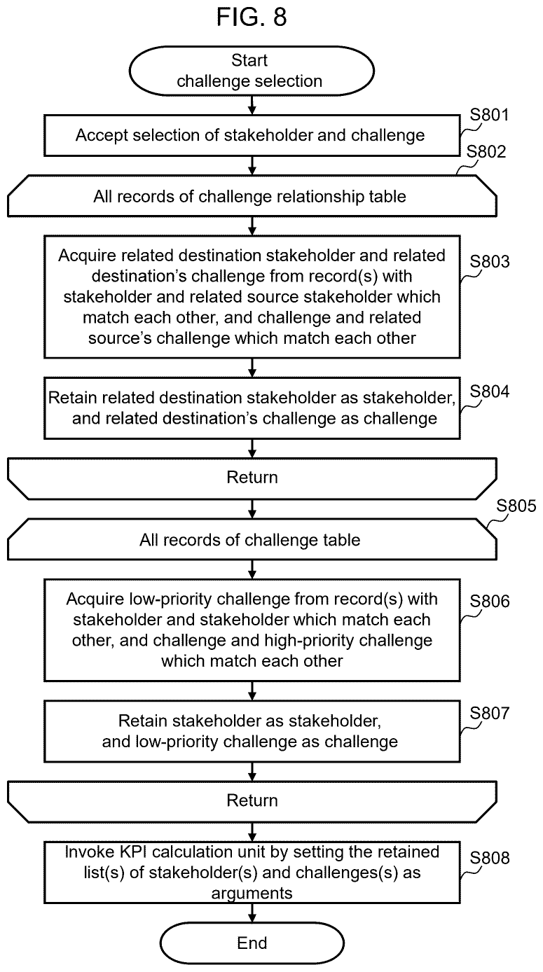

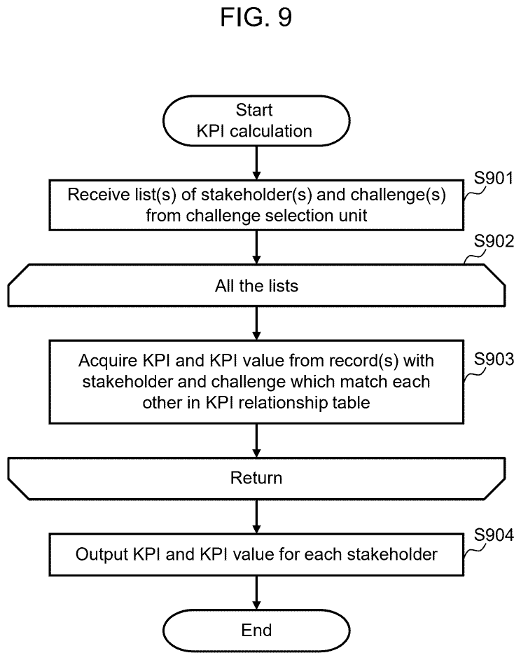

The control unit executes various kinds of data processing based on programs and data stored in the storage unit, and data acquired by the communication unit. Moreover, the control unit executes various kinds of processing such as the graph definition processing (whose details will be described later in relation to FIG. 5), the KPI relationship definition processing (whose details will be described later in relation to FIG. 6), the challenge relationship definition processing (whose details will be described later in relation to FIG. 7), the challenge selection processing (whose details will be described later in relation to FIG. 8), and the KPI calculation processing (whose details will be described later in relation to FIG. 9) which are mentioned earlier. The control unit also functions as an interface for the storage unit and the communication unit.

The control unit has respective functional blocks of a definition unit 210 and an evaluation unit 220 as illustrated in FIG. 2.

The definition unit 210 includes respective functional blocks of a graph definition unit 211, a KPI definition unit 212, and a challenge relationship definition unit 213.

The graph definition unit 211 executes the graph definition processing (whose details will be described later in relation to FIG. 5).

The KPI definition unit 212 executes the KPI relationship definition processing (whose details will be described later in relation to FIG. 6).

The challenge relationship definition unit 213 executes the challenge relationship definition processing (whose details will be described later in relation to FIG. 7).

The evaluation unit 220 includes respective functional blocks of a challenge selection unit 221 and a KPI calculation unit 222.

The challenge selection unit 221 executes the challenge selection processing (whose details will be described later in relation to FIG. 8).

The KPI calculation unit 222 executes the KPI calculation processing (whose details will be described later in relation to FIG. 9).

The control unit is configured by using the processor 101 and can implement these functional blocks by executing the specified KPI evaluation program. Incidentally, the control unit may be configured by using a logic circuit such as an FPGA (Field Programmable Gate Array), instead of the processor 101. Moreover, the control unit may be configured by a combination of the processor 101 and the logic circuit.

The storage unit is configured by using a storage device composed of, for example, the storage device 103 and the memory 102 and stores programs for supplying various kinds of processing instructions to the control unit and data indicating various kinds of information used in the processing to be executed by the control unit.

The storage unit stores, for example, at least a customer information database 230 including a stakeholder table 231, a challenge table 232, and a process table 233, and a relationship database 240 including a KPI relationship table 241 and a challenge relationship table 242.

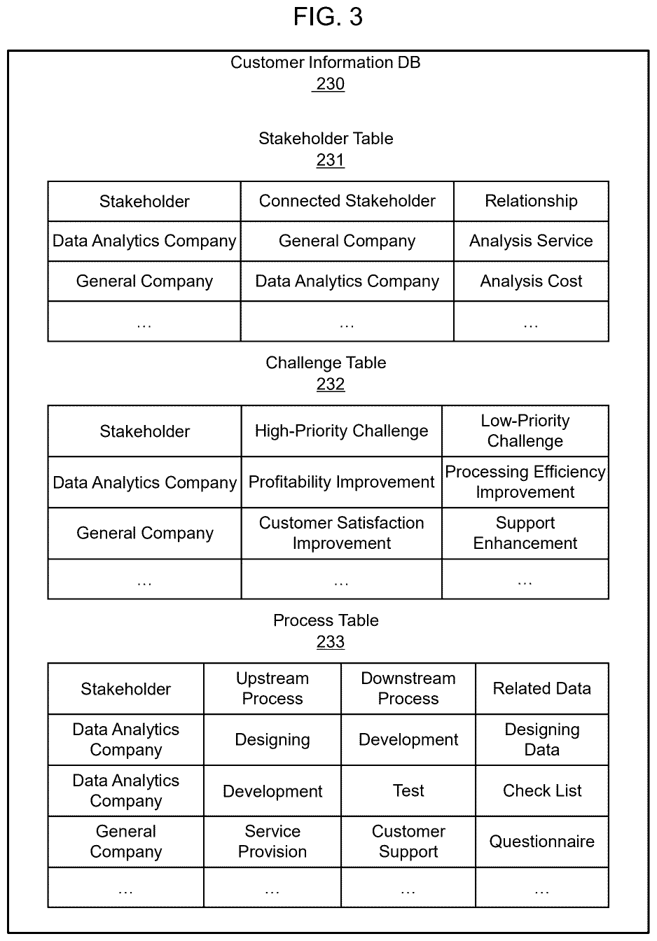

The customer information database 230 is configured by including the stakeholder table 231, the challenge table 232, and the process table 233 as illustrated by an example in FIG. 3.

The stakeholder table 231 is a table for managing information about stakeholders. The stakeholder table 231 has a record for each stakeholder. A record shows, for example, a stakeholder's name, the name of a stakeholder connected to the relevant stakeholder, and the relationship of connecting both the stakeholders. Specifically speaking, the stakeholder table 231 manages connections between stakeholders with respect to each stakeholder by linking and recording, regarding each record, the stakeholder's name, the name of a stakeholder connected to the relevant stakeholder, and the relationship of connecting both the stakeholders. According to an example illustrated in FIG. 3, it is recorded in in the stakeholder table 231 that a “data analytics company” is connected to a “general company” via an “analysis service.”

The challenge table 232 is a table for managing information about challenges which the stakeholders have. The challenge table 232 has a record for each stakeholder. A record shows, for example, a stakeholder's name, a high-priority challenge for the stakeholder, and a low-priority challenge for the stakeholder. Specifically speaking, the challenge table 232 manages the challenges which stakeholders have with respect to each stakeholder by linking and recording, regarding each record, the stakeholder's name, and the high-priority challenge and the low-priority challenge for the relevant stakeholder. According to an example illustrated in FIG. 3, it is recorded in the challenge table 232 that the high-priority challenge for a “data analytics company” is “profitability improvement” and their low-priority challenge is “processing efficiency improvement.”

The process table 233 is a table for managing information regarding business processes of stakeholders. The process table 233 has a record for each stakeholder. A record shows, for example, a stakeholder's name, an upstream process for the stakeholder, a downstream process for the stakeholder, and related data of these processes. Specifically speaking, the process table 233 manages information about the relevant stakeholder's business processes with respect to each stakeholder by linking and recording, regarding each record, the stakeholder's name, the upstream process and the downstream process for the stakeholder, and the related data of these processes. According to an example illustrated in FIG. 3, it is recorded in the challenge table 232 that the upstream process for a “data analytics company” is “designing” and their downstream process is “development,” and the related data of these processes is “designing data.”

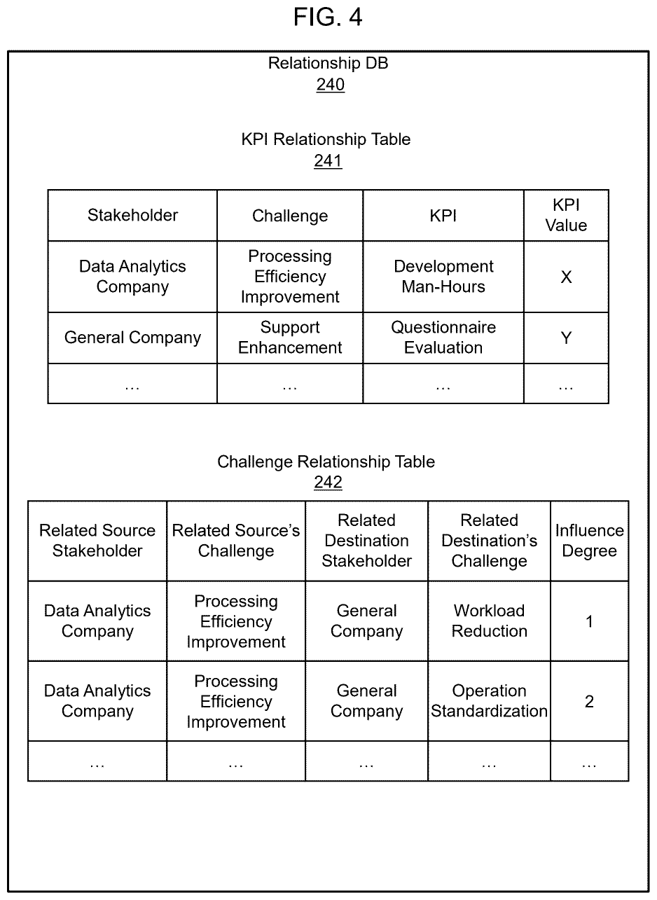

Furthermore, the relationship database 240 is configured by including a KPI relationship table 241 and a challenge relationship table 242 as illustrated by an example in FIG. 4.

The KPI relationship table 241 is a table for managing information about KPIs of stakeholders. The KPI relationship table 241 has a record for each stakeholder. A record shows, for example, a stakeholder's name, a challenge for the stakeholder, a KPI of the stakeholder, and a value of the KPI. Specifically speaking, the KPI relationship table 241 manages information about KPIs of stakeholders with respect to each stakeholder by linking and recording, regarding each record, the stakeholder's name, the challenge for the stakeholder, the KPI of the stakeholder, and the KPI value. According to an example illustrated in FIG. 4, it is recorded in the KPI relationship table 241 that the challenge of a “data analytics company” is “processing efficiency improvement,” the KPI is “development man-hours,” and the KPI value is “X.”

The challenge relationship table 242 is a table for managing information about a challenge relationship. The challenge relationship table 242 has a record for each stakeholder which is a related source (hereinafter referred to as a “related source stakeholder”). A record shows, for example, a related source stakeholder's name, a challenge for the related source stakeholder (hereinafter referred to as a “related source challenge”), the name of a stakeholder which is a related destination (hereinafter referred to as a “related destination stakeholder”) for the related source stakeholder, a challenge for the related destination stakeholder (hereinafter referred to as a “related destination challenge”), and an influence degree thereof. Specifically speaking, the challenge relationship table 242 manages the challenge relationship with respect to each related source stakeholder by linking and recording, regarding each record, the related source stakeholder's name, the related source challenge, the related destination stakeholder's name, the related destination challenge, and the influence degree thereof. According to an example illustrated in FIG. 4, it is recorded in the challenge relationship table 242 that the related source challenge of a “data analytics company” which is the related source stakeholder is “processing efficiency improvement” and the related destination challenge of a “general company” which is the related destination stakeholder is “workload reduction,” and the influence degree thereof is “1.”

The control unit can execute various kinds of processing such as the graph definition processing (whose details will be described later in relation to FIG. 5), the KPI relationship definition processing (whose details will be described later in relation to FIG. 6), the challenge relationship definition processing (whose details will be described later in relation to FIG. 7), the challenge selection processing (whose details will be described later in relation to FIG. 8), and the KPI calculation processing (whose details will be described later in relation to FIG. 9) which are described earlier, by writing and reading these pieces of information to and from the storage unit.

The communication unit is in charge of communication processing with the user terminal 110 and other devices, which is performed via the Internet (an example of the communication network 120). The communication unit is configured by using, for example, an NIC (Network Interface Card) and an HBA (Host Bus Adapter).

The user interface unit is configured by including respective functional blocks of an input unit and an output unit.

Of the processing regarding the user interface, the input unit is in charge of processing regarding inputs such as accepting input operations from a user. The input unit is configured by using the input device 105 such as a keyboard, a pointing device, and a touch panel and detects various kinds of operations from the user.

Of the processing regarding the user interface, the output unit is in charge of processing regarding outputs such as displaying of various kinds of screens on a display device and audio outputs to the display device. The output unit is configured by using an output device (which is not illustrated in the drawing) such as a liquid crystal display and a touch screen.

Specifically speaking, the respective constituent elements of the KPI evaluation system 100 are implemented by hardware including the processor 101, storage devices such as the memory 102 and the storage device 103, and the wired or wireless communication line 107 and the interface devices (104, 105) which connect them, and software which is stored in the storage device 103 and supplies processing instructions to an arithmetic and logic unit.

In this embodiment, it has been explained that the respective functions of the KPI evaluation system 100 are integrally implemented by one computer device. However, these respective functions may be implemented by a plurality of computers and/or servers which are connected to each other. Moreover, the KPI evaluation system 100 may be configured to include a general-purpose computer such as a laptop PC and a web browser installed therein, or may be configured to include a web server and various kinds of mobile equipment.

Moreover, the KPI evaluation system 100 may further have another/other function(s) in addition to the above-mentioned various kinds of functions.

### Processing Flow Examples

Next, an explanation will be provided about each processing executed by the KPI evaluation system 100 according to Example 1 with reference to FIGS. 5 to 9.

### Graph Definition Processing

FIG. 5 is a flowchart illustrating a flow example of the graph definition processing executed by the KPI evaluation system 100 according to this embodiment.

In the graph definition processing illustrated in the flowchart in FIG. 5, the control unit for the KPI evaluation system 100 causes the graph definition unit 211 to repeatedly execute processing in steps S501 to S508 until all inputs are completed. Consequently, the processing in steps S501 to S508 is executed repeatedly until all the inputs are completed. When the processing in step S501 is completed, the control unit for the KPI evaluation system 100 proceeds to step S502.

In step S502, the control unit for the KPI evaluation system 100 causes the graph definition unit 211 to execute processing for accepting a graph definition input operation via the input unit or the communication unit. Consequently, the graph definition input can be accepted. Incidentally, part of the input operation may be accepted regarding this graph definition and the whole definition may be inferred from a similar structure(s) in the past. When the processing in step S502 is completed, the control unit for the KPI evaluation system 100 proceeds to step S503.

In step S503, the control unit for the KPI evaluation system 100 causes the graph definition unit 211 to judge whether a stakeholder is defined or not. If it is determined that the stakeholder is defined (step S503: Yes), the control unit for the KPI evaluation system 100 proceeds to step S504 to store the defined content in the stakeholder table 231; and if it is determined that the stakeholder is not defined (step S503: No), the control unit for the KPI evaluation system 100 directly proceeds to step S505.

In step S504, the control unit for the KPI evaluation system 100 causes the graph definition unit 211 to execute processing for storing the above-mentioned defined content in the stakeholder column, the connected stakeholder column, and the relationship column of the stakeholder table 231, respectively. Consequently, the above-mentioned defined content is stored in the stakeholder column, the connected stakeholder column, and the relationship column of the stakeholder table 231, respectively. When the processing in step S504 is completed, the control unit for the KPI evaluation system 100 proceeds to step S505.

In step S505, the control unit for the KPI evaluation system 100 causes the graph definition unit 211 to execute processing for judging whether a challenge is defined or not. If it is determined that the challenge is defined (step S505: Yes), the control unit for the KPI evaluation system 100 proceeds to step S506 to store the defined content in the challenge table 232; and if it is determined that the challenge is not defined (step S505: No), the control unit for the KPI evaluation system 100 directly proceeds to step S507.

In step S506, the control unit for the KPI evaluation system 100 causes the graph definition unit 211 to execute processing for storing the above-mentioned defined content in the stakeholder column, the high-priority challenge column, and the low-priority challenge column of the challenge table 232, respectively. Consequently, the above-mentioned defined content is stored in the stakeholder column, the high-priority challenge column and the low-priority challenge column of the challenge table 232, respectively. When the processing in step S506 is completed, the control unit for the KPI evaluation system 100 proceeds to step S507.

In step S507, the control unit for the KPI evaluation system 100 causes the graph definition unit 211 to execute processing for judging whether a process is defined or not. If it is determined that the process is defined (step S507: Yes), the control unit for the KPI evaluation system 100 proceeds to step S508 to store the defined content in the process table 233; and if it is determined that the process is not defined (step S507: No), the control unit for the KPI evaluation system 100 returns to step S501 again in order to continue executing the graph definition processing illustrated in the flowchart in FIG. 5.

In step S508, the control unit for the KPI evaluation system 100 causes the graph definition unit 211 to execute processing for storing the above-mentioned defined content in the stakeholder column, the upstream process column, the downstream process column, and the related data column of the process table 233, respectively. Consequently, the above-mentioned defined content is stored in the stakeholder column, the upstream process column, the downstream process column, and the related data column of the process table 233, respectively.

When the processing in step S507 or step S508 is completed, the control unit for the KPI evaluation system 100 returns to step S501 again in order to continue executing the graph definition processing illustrated in the flowchart in FIG. 5. Subsequently, when the processing in steps S501 to S508 is executed repeatedly until all the inputs are completed, the control unit for the KPI evaluation system 100 proceeds to step S509.

In step S509, the control unit for the KPI evaluation system 100 causes the graph definition unit 211 to execute processing for invoking the KPI definition unit 212. Consequently, the KPI definition unit 212 is invoked, so the KPI relationship definition processing illustrated in a flowchart in FIG. 6 can be executed immediately after the graph definition processing illustrated in the flowchart in FIG. 5. When the processing in step S509 is completed, the control unit for the KPI evaluation system 100 terminates the graph definition processing illustrated in the flowchart in FIG. 5.

### KPI Relationship Definition Processing

FIG. 6 is a flowchart illustrating a flow example of the KPI relationship definition processing executed by the KPI evaluation system 100 according to this embodiment.

In the KPI relationship definition processing illustrated in the flowchart in FIG. 6, the control unit for the KPI evaluation system 100 causes the KPI definition unit 212 to repeatedly execute processing in steps S601 to S607 until all the inputs are completed. Consequently, the processing in steps S601 to S607 is executed repeatedly until all the inputs are completed. When the processing in step S601 is completed, the control unit for the KPI evaluation system 100 proceeds to step S602.

In step S602, the control unit for the KPI evaluation system 100 causes the KPI definition unit 212 to execute processing for accepting an input operation of a KPI relationship definition via the input unit or the communication unit. Consequently, the input of the KPI relationship definition can be accepted. Incidentally, the input operation may be accepted regarding part of this KPI relationship definition and the whole definition may be inferred from a similar structure(s) in the past. When the processing in step S602 is completed, the control unit for the KPI evaluation system 100 proceeds to step S603.

In step S603, the control unit for the KPI evaluation system 100 causes the KPI definition unit 212 to execute processing for retaining the stakeholder, the challenge, and the KPI. Consequently, the stakeholder, the challenge, and the KPI are retained. When the processing in step S603 is completed, the control unit for the KPI evaluation system 100 proceeds to step S604.

In the KPI relationship definition processing illustrated in the flowchart in FIG. 6, the control unit for the KPI evaluation system 100 causes the KPI definition unit 212 to repeatedly execute processing in steps S604 to S606 until the relevant processing is completed with respect to the entire process table 233. Consequently, the processing in steps S604 to S606 is repeatedly executed until the relevant processing is completed with respect to the entire process table 233. When the processing in step S604 is completed, the control unit for the KPI evaluation system 100 proceeds to step S605.

In step S605, the control unit for the KPI evaluation system 100 causes the KPI definition unit 212 to execute processing for acquiring the upstream process, the downstream process, and the related data from a record(s)with a matching stakeholder in the process table 233. Consequently, the upstream process, the downstream process, and the related data are acquired from the record(s) with the matching stakeholder in the process table 233. When the processing in step S605 is completed, the control unit for the KPI evaluation system 100 proceeds to step S606.

In step S606, the control unit for the KPI evaluation system 100 causes the KPI definition unit 212 to execute processing for calculating the KPI value based on the process connection and the related data. Consequently, the KPI value is calculated based on the process connection and the related data. Incidentally, the KPI may be extracted from the process by using, for example, 1DCAE or TOC. Moreover, the KPI calculation method may be defined in advance. When the processing in step S606 is completed, the control unit for the KPI evaluation system 100 proceeds to step S607.

When the processing in step S606 is completed, the control unit for the KPI evaluation system 100 returns to step S604 again in order to continue executing the relevant processing. Subsequently, when the processing in steps S604 to S606 is repeatedly executed until the relevant processing is completed with respect to the entire process table 233, the control unit for the KPI evaluation system 100 proceeds to step S607.

In step S607, the control unit for the KPI evaluation system 100 causes the KPI definition unit 212 to execute processing for storing the results of the processing until step S606 in the stakeholder column, the challenge column, the KPI column, and the KPI value column of the KPI relationship table 241, respectively. Consequently, the results of the processing until step S606 are stored in the stakeholder column, the challenge column, the KPI column, and the KPI value column of the KPI relationship table 241, respectively.

When the processing in step S607 is completed, the control unit for the KPI evaluation system 100 returns to step S601 again in order to continue executing the KPI relationship definition processing illustrated in the flowchart in FIG. 6. Subsequently, when the processing in steps S601 to S607 is repeatedly executed until all the inputs are completed, the control unit for the KPI evaluation system 100 proceeds to step S608.

In step S608, the control unit for the KPI evaluation system 100 causes the KPI definition unit 212 to execute processing for invoking the challenge relationship definition unit 213. Consequently, the challenge relationship definition unit 213 is invoked, so the challenge relationship definition processing illustrated in a flowchart in FIG. 7 can be executed immediately after the KPI relationship definition processing illustrated in the flowchart in FIG. 6. When the processing in step S608 is completed, the control unit for the KPI evaluation system 100 terminates the KPI relationship definition processing illustrated in the flowchart in FIG. 6.

### Challenge Relationship Definition Processing

FIG. 7 is a flowchart illustrating a flow example of the challenge relationship definition processing executed by the KPI evaluation system 100 according to this embodiment.

In the challenge relationship definition processing illustrated in the flowchart in FIG. 7, the control unit for the KPI evaluation system 100 causes the challenge relationship definition unit 213 to repeatedly execute processing in steps S701 to S703 until all the inputs are completed. Consequently, the processing in steps S701 to S703 is repeatedly executed until all the inputs are completed. When the processing in step S701 is completed, the control unit for the KPI evaluation system 100 proceeds to step S702.

In step S702, the control unit for the KPI evaluation system 100 causes the challenge relationship definition unit 213 to execute processing for accepting an input operation of a challenge relationship definition via the input unit or the communication unit. Consequently, the input of the challenge relationship definition can be accepted. Incidentally, the input operation may be accepted regarding part of this challenge relationship definition and the whole definition may be inferred from a similar structure(s) in the past. When the processing in step S702 is completed, the control unit for the KPI evaluation system 100 proceeds to step S703.

In step S703, the control unit for the KPI evaluation system 100 causes the challenge relationship definition unit 213 to execute processing for storing the content of the input operation accepted in step S702 in the related source stakeholder column, the related source's challenge column, the related destination stakeholder column, the related destination's challenge column, and the influence degree column of the challenge relationship table 242. Consequently, the content of the relevant input operation is stored in the related source stakeholder column, the related source's challenge column, the related destination stakeholder column, the related destination's challenge column, and the influence degree column of the challenge relationship table 242, respectively.

When the processing in step S703 is completed, the control unit for the KPI evaluation system 100 returns to step S701 again in order to continue executing the challenge relationship definition processing illustrated in the flowchart in FIG. 7. Subsequently, when the processing in steps S701 to S703 is repeatedly executed until all the inputs are completed, the control unit for the KPI evaluation system 100 terminates the challenge relationship definition processing illustrated in the flowchart in FIG. 7.

### Challenge Selection Processing

FIG. 8 is a flowchart illustrating a flow example of the challenge selection processing executed by the KPI evaluation system 100 according to this embodiment.

In step S801, the control unit for the KPI evaluation system 100 causes the challenge selection unit 221 to execute processing for accepting an operation to select the stakeholder and the challenge. Consequently, the selection of the stakeholder and the challenge can be accepted. When the processing in step S801 is completed, the control unit for the KPI evaluation system 100 proceeds to step S802.

In the challenge selection processing illustrated in the flowchart in FIG. 8, the control unit for the KPI evaluation system 100 causes the challenge selection unit 221 to repeatedly execute processing in steps S802 to S804 until the relevant processing is completed with respect to all records of the challenge relationship table 242. Consequently, the processing in steps S802 to S804 is repeatedly executed until the relevant processing is completed with respect to all the records of the challenge relationship table 242. When the processing in step S802 is completed, the control unit for the KPI evaluation system 100 proceeds to step S803.

In step S803, the control unit for the KPI evaluation system 100 causes the challenge selection unit 221 to execute processing for acquiring the related destination stakeholder and the related destination's challenge from a record(s) in which the stakeholder and the related source stakeholder match each other and the challenge and the related source's challenge match each other. Consequently, the related destination stakeholder and the related destination's challenge are acquired from the record(s) in which the stakeholder and the related source stakeholder match each other and the challenge and the related source's challenge match each other. When the processing in step S803 is completed, the control unit for the KPI evaluation system 100 proceeds to step S804.

In step S804, the control unit for the KPI evaluation system 100 causes the challenge selection unit 221 to execute processing for retaining the related destination stakeholder as the stakeholder and retaining the related destination's challenge as the challenge, respectively. Consequently, the related destination stakeholder is retained as the stakeholder and the related destination's challenge is retained as the challenge, respectively. When the processing in step S804 is completed, the control unit for the KPI evaluation system 100 proceeds to step S805.

When the processing in step S804 is completed, the control unit for the KPI evaluation system 100 returns to step S802 again in order to continue executing the relevant processing. Subsequently, when the processing in steps S802 to S804 is repeatedly executed until the relevant processing is completed with respect to the entire challenge relationship table 242, the control unit for the KPI evaluation system 100 proceeds to step S805.

In the challenge selection processing illustrated in the flowchart in FIG. 8, the control unit for the KPI evaluation system 100 causes the challenge selection unit 221 to execute processing in steps S805 to S807 until the relevant processing is completed with respect to all records of the challenge table 232. Consequently, the processing in steps S805 to S807 is repeatedly executed until the relevant processing is completed with respect to all the records of the challenge table 232. When the processing in step S805 is completed, the control unit for the KPI evaluation system 100 proceeds to step S806.

In step S806, the control unit for the KPI evaluation system 100 causes the challenge selection unit 221 to execute processing for acquiring the low-priority challenge from a record(s) in which the stakeholder and the stakeholder match each other and the challenge and the high-priority challenge match each other. Consequently, the low-priority challenge is acquired from the record(s) in which the stakeholder and the stakeholder match each other and the challenge and the high-priority challenge match each other. When the processing in step S806 is completed, the control unit for the KPI evaluation system 100 proceeds to step S807.

In step S807, the control unit for the KPI evaluation system 100 causes the challenge selection unit 221 to execute processing for retaining the stakeholder as the stakeholder and retaining the low-priority challenge as the challenge, respectively. Consequently, the stakeholder is retained as the stakeholder and the low-priority challenge is retained as the challenge, respectively.

When the processing in step S807 is completed, the control unit for the KPI evaluation system 100 returns to step S805 in order to continue executing the relevant processing. Subsequently, when the processing in steps S805 to S807 is executed repeatedly until the relevant processing is completed with respect to the entire challenge table 232, the control unit for the KPI evaluation system 100 proceeds to step S808.

In step S808, the control unit for the KPI evaluation system 100 causes the challenge selection unit 221 to execute processing for invoking the KPI calculation unit 222 by setting the list(s) of the retained stakeholder(s) and retained challenge(s) as arguments. Consequently, the KPI calculation unit 222 is invoking by setting the list(s) of the retained stakeholder(s) and challenge(s) as the arguments, so the KPI calculation processing illustrated in a flowchart in FIG. 9 can be executed immediately after the challenge selection processing illustrated in the flowchart in FIG. 8. When the processing in step S808 is completed, the control unit for the KPI evaluation system 100 terminates the challenge selection processing illustrated in the flowchart in FIG. 8.

### KPI Calculation Processing

FIG. 9 is a flowchart illustrating a flow example of the KPI calculation processing executed by the KPI evaluation system 100 according to this embodiment.

In step S901, the control unit for the KPI evaluation system 100 causes the KPI calculation unit 222 to execute processing for receiving the list(s) of stakeholder(s) and challenge(s) from the challenge selection unit 221. Consequently, the list(s) of the stakeholder(s) and the challenge(s) can be received from the challenge selection unit 221. When the processing in step S901 is completed, the control unit for the KPI evaluation system 100 proceeds to step S902.

In the KPI calculation processing illustrated in the flowchart in FIG. 9, the control unit for the KPI evaluation system 100 causes the KPI calculation unit 222 to repeatedly execute processing in steps S902 and S903 until the relevant processing is completed with respect to all the lists. Consequently, the processing in steps S902 and S903 is executed repeatedly until the relevant processing is completed with respect to all the lists. When the processing in step S902 is completed, the control unit for the KPI evaluation system 100 proceeds to step S903.

In step S903, the control unit for the KPI evaluation system 100 causes the KPI calculation unit 222 to execute processing for acquiring the KPI and the KPI value from a record(s) in which the stakeholder and the challenge match each other in the KPI relationship table 241. Consequently, the KPI and the KPI value are acquired from the record(s) in which the stakeholder and the challenge match each other in the KPI relationship table 241.

When the processing in step S903 is completed, the control unit for the KPI evaluation system 100 returns to step S902 again in order to continue executing the relevant processing. Subsequently, when the processing in steps S902 and S903 is executed repeatedly until the relevant processing is completed with respect to all the lists, the control unit for the KPI evaluation system 100 proceeds to step S904.

In step S904, the control unit for the KPI evaluation system 100 causes the KPI calculation unit 222 to execute processing for outputting the KPI and the KPI value for each stakeholder. Consequently, the KPI and the KPI value are output for each stakeholder. When the processing in step S904 is completed, the control unit for the KPI evaluation system 100 terminates the KPI calculation processing illustrated in the flowchart in FIG. 9.

### Example 2

### Configuration Example of KPI Evaluation System 100

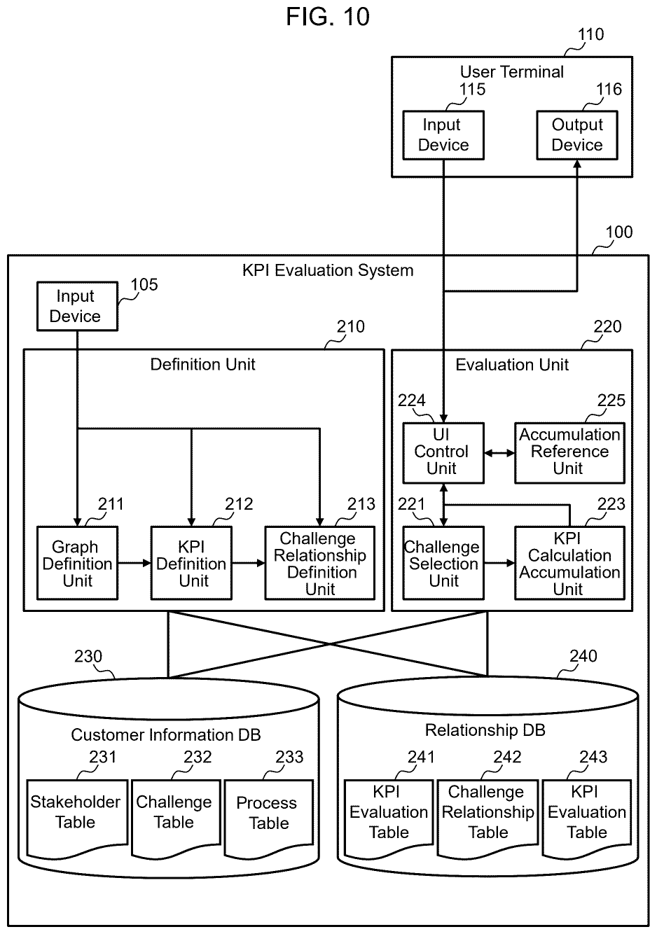

Next, an explanation will be provided about a configuration example of the KPI evaluation system 100 according to Example 2 with reference to FIG. 1 and FIG. 10.

### Configuration Example of the Entire System

Incidentally, the configuration of the entire system of the KPI evaluation system 100 according to Example 2 is similar to an example of the configuration of the entire system of the KPI evaluation system 100 according to Example 1 described earlier with reference to FIG. 1, so an explanation about it is omitted.

### Hardware Configuration Example of KPI Evaluation System 100 and User Terminal 110

Furthermore, the hardware configuration of the KPI evaluation system 100 and the user terminal 110 according to Example 2 is similar to an example of the hardware configuration of the KPI evaluation system 100 and the user terminal 110 according to Example 1 described earlier with reference to FIG. 1, an explanation about it is omitted.

### Functional Block Example of KPI Evaluation System 100 according to Example 2

Next, an example of various kinds of functional blocks possessed by the KPI evaluation system 100 according to Example 2 will be explained with reference to FIG. 10. Incidentally, each block explained below indicates a function-based block, but not a hardware-based configuration.

As illustrated in FIG. 10, the KPI evaluation system 100 according to Example 2 has the differences described below with respect to the respective functional blocks of a control unit and a storage unit as compared to the KPI evaluation system 100 according to Example 1. Other configurations of the KPI evaluation system 100 according to Example 2 are similar to those of the KPI evaluation system 100 according to Example 1, so only such differences will be described here.

With the KPI evaluation system 100 according to Example 2, an evaluation unit 220 of the control unit includes, as illustrated in FIG. 10, respective functional blocks of a challenge selection unit 221, a KPI calculation accumulation unit 223, a UI control unit 224, and an accumulation reference unit 225. Specifically speaking, as compared to the evaluation unit 220 for the KPI evaluation system 100 according to Example 1, the evaluation unit 220 for the KPI evaluation system 100 according to Example 2 does not include the KPI calculation unit 222, but instead includes a KPI calculation accumulation unit 223, a UI control unit 224, and an accumulation reference unit 225.

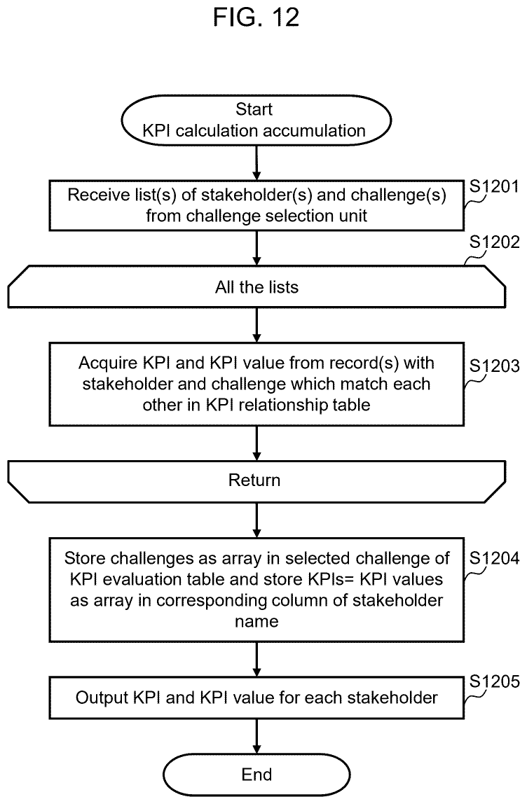

The KPI calculation accumulation unit 223 executes KPI calculation accumulation processing (whose details will be described later in relation to FIG. 12).

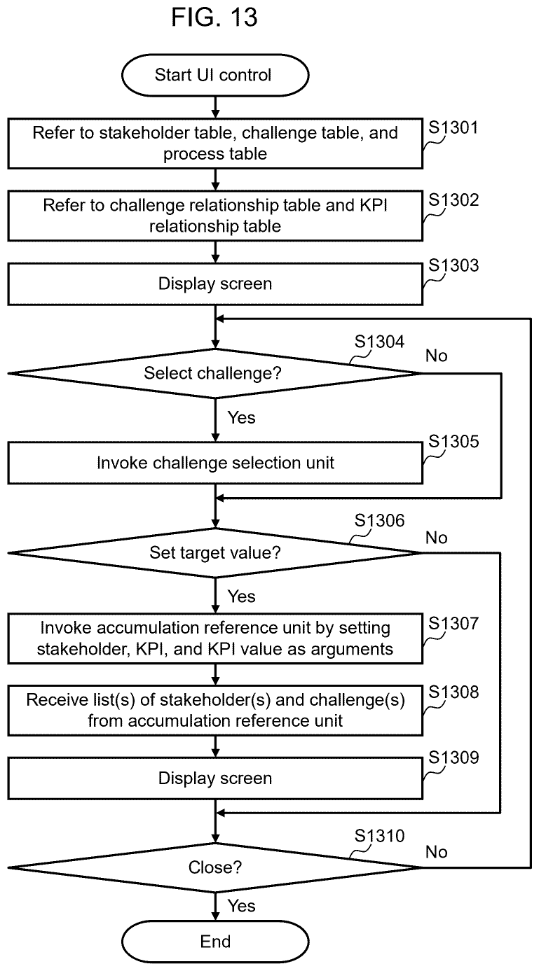

The UI control unit 224 executes UI control processing (whose details will be described later in relation to FIG. 13).

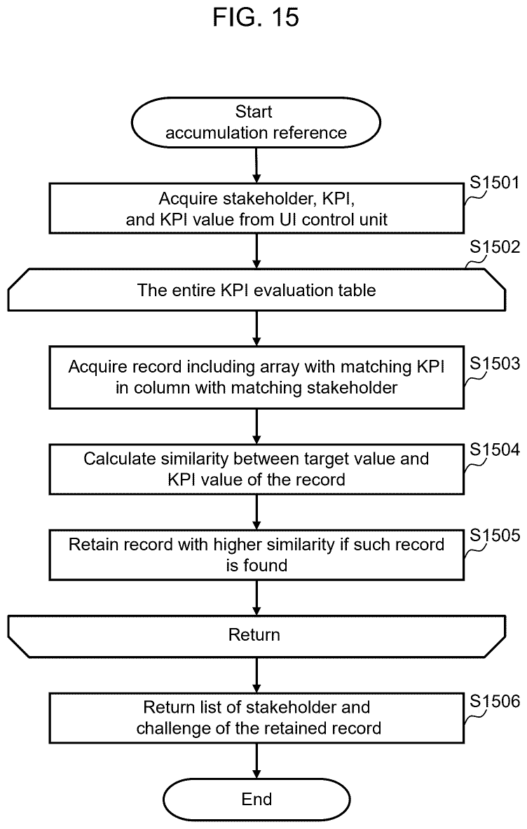

The accumulation reference unit 225 executes accumulation reference processing (whose details will be described later in relation to FIG. 15).

Furthermore, with the KPI evaluation system 100 according to Example 2, the relationship database 240 stored in the storage unit is configured by including, as illustrated in FIG. 10, a KPI relationship table 241, a challenge relationship table 242, and a KPI evaluation table 243. Specifically speaking, the relationship database 240 possessed by the KPI evaluation system 100 according to Example 2 further includes a KPI evaluation table 243 as compared to the relationship database 240 possessed by the KPI evaluation system 100 according to Example 1.

The KPI evaluation table 243 is a table for managing information regarding evaluation of the stakeholders' KPIs (hereinafter referred to as “KPI evaluation”). The KPI evaluation table 243 has a record for each stakeholder. A record shows, for example, a stakeholder's selected challenge, an evaluation value of a KPI regarding the selected challenge by a data analytics company, and an evaluation value of the KPI by a general company. Specifically speaking, the KPI evaluation table 243 manages the information about the KPI evaluation for each stakeholder by linking and recording, regarding each record, the stakeholder's name, the stakeholder's selected challenge, the evaluation value of the KPI regarding the selected challenge by the data analytics company, and the evaluation value of the KPI by the general company. According to an example illustrated in FIG. 4, it is recorded in the KPI evaluation table 243 that the selected challenge of the “data analytics company” is “processing efficiency improvement,” the evaluation value of the KPI regarding the selected challenge by the data analytics company is “α=X, β=Y,” and the evaluation value of the KPI by the general company is “γ=Z.”

### Processing Flow Examples

Next, an explanation will be provided about each processing executed by the KPI evaluation system 100 according to Example 2 with reference to FIGS. 12 to 14.

### KPI Calculation Accumulation Processing

FIG. 12 is a flowchart illustrating a flow example of the KPI calculation accumulation processing executed by the KPI evaluation system 100 according to this embodiment.

In step S1201, the control unit for the KPI evaluation system 100 causes the KPI calculation accumulation unit 223 to execute processing for receiving the list(s) of the stakeholder(s) and the challenge(s) from the challenge selection unit 221. Consequently, the list(s) of the stakeholder(s) and the challenge(s) can be received from the challenge selection unit 221. When the processing in step S1201 is completed, the control unit for the KPI evaluation system 100 proceeds to step S1202.

In the KPI calculation accumulation processing illustrated in the flowchart in FIG. 12, the control unit for the KPI evaluation system 100 causes the KPI calculation accumulation unit 223 to repeatedly execute processing in steps S1202 and S1203 until the relevant processing is completed with respect to all the lists. Consequently, the processing in steps S1202 and S1203 is executed repeatedly until the relevant processing is completed with respect to all the lists. When the processing in step S1202 is completed, the control unit for the KPI evaluation system 100 proceeds to step S1203.

In step S1203, the control unit for the KPI evaluation system 100 causes the KPI calculation accumulation unit 223 to execute processing for acquiring the KPI and the KPI value from a record(s) in which the stakeholder and the challenge match each other in the KPI relationship table 241. Consequently, the KPI and the KPI value can be acquired from the record(s) in which the stakeholder and the challenge match each other in the KPI relationship table 241.

When the processing in step S1203 is completed, the control unit for the KPI evaluation system 100 returns to step S1202 again in order to continue executing the relevant processing. Subsequently, when the processing in steps S1202 and S1203 is executed repeatedly until the relevant processing is completed with respect to all the lists, the control unit for the KPI evaluation system 100 proceeds to step S1204.

In step S1204, the control unit for the KPI evaluation system 100 causes the KPI calculation accumulation unit 223 to store the challenges as an array in the selected challenge column and the KPIs=the KPI values as an array in the relevant column of the stakeholder name in in the KPI evaluation table 243. Consequently, in the KPI evaluation table 243, the challenges are stored as the array in the selected challenge column and the KPIs=the KPI values are stored as the array in the relevant column of the stakeholder name. When the processing in step S1204 is completed, the control unit for the KPI evaluation system 100 proceeds to step S1205.

In step S1205, the control unit for the KPI evaluation system 100 causes the KPI calculation accumulation unit 223 to execute processing for outputting the KPI and the KPI value for each stakeholder. Consequently, the KPI and the KPI value are output for each stakeholder. When the processing in step S1205 is completed, the control unit for the KPI evaluation system 100 terminates the KPI calculation accumulation processing illustrated in the flowchart in FIG. 12.

### UI Control Processing

FIG. 13 is a flowchart illustrating a flow example of the UI control processing executed by the KPI evaluation system 100 according to this embodiment.

In step S1301, the control unit for the KPI evaluation system 100 causes the UI control unit 224 to execute processing for referring to the stakeholder table 231, the challenge table 232, and the process table 233. Consequently, the stakeholder table 231, the challenge table 232, and the process table 233 are referenced. When the processing in step S1301 is completed, the control unit for the KPI evaluation system 100 proceeds to step S1302.

In step S1302, the control unit for the KPI evaluation system 100 causes the UI control unit 224 to execute processing for referring to the challenge relationship table 242 and the KPI relationship table 241. Consequently, the challenge relationship table 242 and the KPI relationship table 241 are referenced. When the processing in step S1302 is completed, the control unit for the KPI evaluation system 100 proceeds to step S1303.

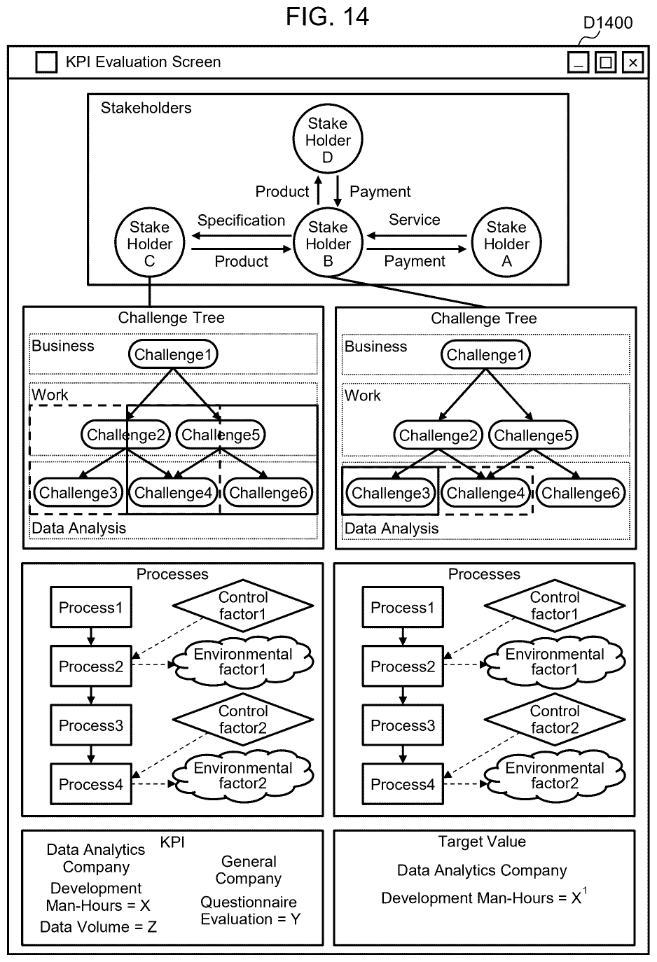

In step S1303, the control unit for the KPI evaluation system 100 causes the UI control unit 224 to execute processing for displaying the reference results on a KPI evaluation screen D1400 illustrated by an example in FIG. 14. Consequently, the reference results are displayed on the KPI evaluation screen D1400 illustrated by the example in FIG. 14. When the processing in step S1303 is completed, the control unit for the KPI evaluation system 100 proceeds to step S1304.

In step S1304, the control unit for the KPI evaluation system 100 causes the UI control unit 224 to execute processing for judging whether to select a challenge or not. If it is determined to select the challenge (step S1304: Yes), the control unit for the KPI evaluation system 100 proceeds to step S1305 in order to select the challenge; and if it is determined to not select the challenge (step S1304: No), the control unit for the KPI evaluation system 100 directly proceeds to step S1306.

In step S1305, the control unit for the KPI evaluation system 100 causes the UI control unit 224 to execute processing for invoking the challenge selection unit 221. Consequently, the challenge selection unit 221 is invoked and the processing for selecting the challenge is executed. When the processing in step S1305 is completed, the control unit for the KPI evaluation system 100 proceeds to step S1306.

In step S1306, the control unit for the KPI evaluation system 100 causes the UI control unit 224 to execute processing for judging whether to set a target value or not. If it is determined to set the target value (step S1306: Yes), the control unit for the KPI evaluation system 100 proceeds to step S1307 in order to set the target value; and if it is determined to not set the target value (step S1306: No), the control unit for the KPI evaluation system 100 directly proceeds to step S1310.

In step S1307, the control unit for the KPI evaluation system 100 causes the UI control unit 224 to execute processing for invoking the accumulation reference unit 225 by setting the stakeholder, the KPI, and the KPI value as arguments. Consequently, the accumulation reference unit 225 is invoked by setting the stakeholder, the KPI, and the KPI value as the arguments. When the processing in step S1307 is completed, the control unit for the KPI evaluation system 100 proceeds to step S1308.

In step S1308, the control unit for the KPI evaluation system 100 causes the UI control unit 224 to execute processing for receiving the list(s) of the stakeholder(s) and the challenge(s) from the accumulation reference unit 225. Consequently, the list(s) of the stakeholder(s) and the challenge(s) can be received from the accumulation reference unit 225. When the processing in step S1308 is completed, the control unit for the KPI evaluation system 100 proceeds to step S1309.

In step S1309, the control unit for the KPI evaluation system 100 causes the UI control unit 224 to execute processing for displaying processing results on the KPI evaluation screen D1400 illustrated by the example in FIG. 14. Consequently, the processing results are displayed on the KPI evaluation screen D1400 illustrated by the example in FIG. 14. When the processing in step S1309 is completed, the control unit for the KPI evaluation system 100 proceeds to step S1310.

In step S1310, the control unit for the KPI evaluation system 100 causes the UI control unit 224 to execute processing for judging whether to close the KPI evaluation screen D1400 or not. On one hand, if it is determined to close the KPI evaluation screen D1400 (step S1310: Yes), the control unit for the KPI evaluation system 100 directly terminates the UI control processing illustrated in the flowchart in FIG. 13. On the other hand, if it is determined to not close the KPI evaluation screen D1400 (step S1310: No), the control unit for the KPI evaluation system 100 returns to step S1304 again in order to continue executing the UI control processing.

### Accumulation Reference Processing

FIG. 15 is a flowchart illustrating a flow example of the accumulation reference processing executed by the KPI evaluation system 100 according to this embodiment.

In step S1501, the control unit for the KPI evaluation system 100 causes the accumulation reference unit 225 to execute processing for acquiring the stakeholder, the KPI, and the KPI value from the UI control unit 224. Consequently, the stakeholder, the KPI, and the KPI value are acquired from the UI control unit 224. When the processing in step S1501 is completed, the control unit for the KPI evaluation system 100 proceeds to step S1502.

In the accumulation reference processing illustrated in the flowchart in FIG. 15, the control unit for the KPI evaluation system 100 causes the accumulation reference unit 225 to repeatedly execute processing in steps S1502 to S1505 until the relevant processing is completed with respect to the entire KPI evaluation table 243. Consequently, the processing in steps S1502 to S1505 is executed repeatedly until the relevant processing is completed with respect to the entire KPI evaluation table 243. When the processing in step S1502 is completed, the control unit for the KPI evaluation system 100 proceeds to step S1503.

In step S1503, the control unit for the KPI evaluation system 100 causes the accumulation reference unit 225 to execute processing for acquiring a record(s) including an array with a matching KPI in a column with a matching stakeholder. Consequently, the record(s) including the array with the matching KPI in the column with the matching stakeholder is acquired. When the processing in step S1503 is completed, the control unit for the KPI evaluation system 100 proceeds to step S1504.

In step S1504, the control unit for the KPI evaluation system 100 causes the accumulation reference unit 225 to execute processing for calculating similarity between the target value and the KPI value of the record. Consequently, the similarity regarding the KPI value between the target value and the record is calculated. Incidentally, this similarity may be evaluated as a cosine distance or may be evaluated as a small difference or ratio. When the processing in step S1504 is completed, the control unit for the KPI evaluation system 100 proceeds to step S1505.

In step S1505, the control unit for the KPI evaluation system 100 causes the accumulation reference unit 225 to execute processing for retaining a record with higher similarity if such record is found. Consequently, if a record with the higher similarity is found, that record is retained.

When the processing in step S1505 is completed, the control unit for the KPI evaluation system 100 returns to step S1502 again in order to continue executing the accumulation reference processing illustrated in the flowchart in FIG. 15. Subsequently, when the processing in steps S1502 to S1505 is executed repeatedly until the relevant processing is completed with respect to the entire KPI evaluation table 243, the control unit for the KPI evaluation system 100 proceeds to step S1506.

In step S1506, the control unit for the KPI evaluation system 100 causes the accumulation reference unit 225 to return the list of the stakeholder and the challenge of the retained record. Consequently, the list of the stakeholder and the challenge of the retained record is returned. When the processing in step S1506 is completed, the control unit for the KPI evaluation system 100 terminates the accumulation reference processing illustrated in the flowchart in FIG. 15.

The embodiments of the present invention described above can be summarized as follows.
(1) The KPI evaluation system 100 is a system for evaluating a KPI(s) (Key Performance Indicator(s)) related to business of a stakeholder, wherein a computer including at least the processor 101, the memory 102, and the storage device 103: defines a relationship between challenges of respective stakeholders regarding two or more stakeholders including the above-mentioned stakeholder; and associates KPI settings of a stakeholder, which is not the above-mentioned stakeholder, with the respective stakeholders' challenges based on the defined relationship between the challenges. Consequently, the KPI evaluation system 100 can express the interconnectivity by defining the KPI relationship between the stakeholders based on the challenges as starting points. As a result, the user of the KPI evaluation system 100 can obtain a plurality of solutions which are harmonized as a whole in consideration of the feasibility, so that upon the analysis of the business KPIs, it is possible to decide the scope and priorities of the challenges while recognizing all the KPIs, and derive measures which are harmonized as a whole from the respective perspectives of values for a company and a customer(s).
(2) The challenges are defined as a challenge tree expressed in a tree format.
(3) A challenge related to a plurality of KPIs is defined from business and action processes of the stakeholder.
(4) When part of the definition is input, the entire definition is inferred from a similar structure in the past.
(5) A plurality of KPI changes of each stakeholder are calculated according to the selection of the challenge tree.
(6) A selection range of the challenge tree towards a target value is suggested from KPI changes of each stakeholder.

Incidentally, the present invention is not limited to the above-described embodiments and can be implemented by using arbitrary constituent elements within the scope without departing from its gist.

The above-described embodiments, examples, and variations are just examples and the present invention is not limited to their content unless the features of the invention are impaired. Also, the various embodiments, examples, and variations have been described above, but the present invention is not limited to their content. Other aspects which can be thought of within the scope of the technical idea of the present invention are also included within the scope of the present invention.

In each aforementioned drawing, control lines and information lines which are considered to be necessary for the explanation are indicated; however, not all control lines or information lines for implementation may be necessarily indicated. For example, it may be considered that practically almost all the components are connected to each other.

Furthermore, the aforementioned arrangement pattern of the respective functional units of the KPI evaluation system 100 explained above is merely one example. The arrangement pattern of the respective functional units can be changed to an optimum arrangement pattern from the viewpoint of the performance, processing efficiency, communication efficiency, etc. of the hardware and software possessed by the KPI evaluation system 100.

### Reference Signs List

100: KPI evaluation system

1. A KPI evaluation system for evaluating a KPI (Key Performance Indicator) related to business of a stakeholder,
wherein a computer comprising at least a processor, a memory, and a storage device:
defines a relationship between challenges of respective stakeholders regarding two or more stakeholders including the above-mentioned stakeholder; and
associates KPI settings of a stakeholder, which is not the above-mentioned stakeholder, with the respective stakeholders' challenges based on the defined relationship between the challenges.

2. The KPI evaluation system according to claim 1,
wherein the challenges are defined as a challenge tree expressed in a tree format.

3. The KPI evaluation system according to claim 1,
wherein a challenge related to a plurality of KPIs is defined from business and action processes of the stakeholder.

4. The KPI evaluation system according to claim 1,
wherein when part of the definition is input, the entire definition is inferred from a similar structure in the past.

5. The KPI evaluation system according to claim 2,
wherein a plurality of KPI changes of each stakeholder are calculated according to the selection of the challenge tree.

6. The KPI evaluation system according to claim 2,
wherein a selection range of the challenge tree towards a target value is suggested from KPI changes of each stakeholder.

7. A KPI evaluation method for evaluating a KPI (Key Performance Indicator) related to business of a stakeholder,
wherein a computer comprising at least a processor, a memory, and a storage device:
defines a relationship between challenges of respective stakeholders regarding two or more stakeholders including the above-mentioned stakeholder; and
associates KPI settings of a stakeholder, which is not the above-mentioned stakeholder, with the challenges of the respective stakeholders based on the defined relationship between the challenges.
